(19) United States
(12) Patent Application Publication
(10) Pub. No.: US 2016/0075454 A1
(43) Pub. Date: Mar. 17, 2016

(54) Spherical Aerospace Fuselage

(71) Applicant: Roland Arthur Smith, JR., San Luis Obispo, CA (US)

(72) Inventor: Roland Arthur Smith, JR., San Luis Obispo, CA (US)

(21) Appl. No.: 14/037,630

(22) Filed: Dec. 5, 2013

Related U.S. Application Data
(60) Provisional application No. 61/722,980, filed on Nov. 6, 2012.

(51) Int. Cl. B64G 1/40

(52) U.S. Cl. CPC B64G 1/40

(57) ABSTRACT

The invention relates to aerospace fuselages or space vehicles comprising a spherical shape used to hold at least one propulsion device. A method of providing a way to correctly move, stop, and change directions in space since multi-directional propulsion is now available at any instant in time without the need to rotate a fuselage. when using a plurality of propulsion devices distributed on or within the bulkhead of the spherical fuselage.

### CROSS-REFERENCE TO RELATED APPLICATIONS

The applicant claims the benefit of provisional patent application Ser. No. 61/722,980 filed 2012 Nov. 6 by the present inventor.

### BACKGROUND

### Description of Prior Art

The following is a tabulation of some prior art that presently appears relevant:

U.S. Patents

| Patent Number | Kind Code | Issue Date | Patentee |
|---|---|---|---|
| U.S. Pat. No. 6,698,684 | B1 | Mar. 2, 2004 | Preston A. Henne |
| EP 0217117 | A1 | Jun. 8, 1988 | Gerhard Stephen |
| EP 2589532 | A2 | May 8, 2013 | Elena Arevalo |

Moving through space correctly or accurately is not something people normally contemplate or understand. When considering the future of space travel and the theoretical future of space propulsion devices (and subsequent velocities associated with there improvements) certain stability and control needs and speed limit constraints may no longer be needed. A new and novel aerospace fuselage is needed. A fuselage that will allow an aerospace vehicle to move through space more effectively is needed.

When moving from a relative stopped position to a desired directional vector an aerospace fuselage of today has to turn or rotate. Then, a propulsion device can be activated to move the vehicle in the right direction. For example, the space shuttle has one main rocket assembly. The fuselage has to be moved or rotated. Then, the rockets can be used to start moving in a desired direction. This is cumbersome and takes time to complete. Clearly, this is not the correct way to move into a desired direction in space.

While already moving through space, an aerospace fuselage of today has to turn or rotate to change is directional vector. Then, a propulsion device can be activated to change direction. This is cumbersome and takes time to complete. When traveling at high velocities any delay in course alteration equates to large errors associated with distances. You might miss a turn by thousands of miles or more. You might miss a turn and have to stop (go back) and try it again. Obviously, there is a need to find a better way to change course directions in space.

When attempting a stopping maneuver an aerospace fuselage of today has to be turned completely around. Then, a propulsion device can be activated to remove velocity from the ship. This is cumbersome and takes time to complete. You might need to quickly stop to keep from impacting something in space. Not having enough time to perform this maneuver could cause catastrophic damage. Not having enough time to perform this maneuver could kill you. Being forced to turn your fuselage to attempt a stopping maneuver is not acceptable.

Nevertheless all the aerospace fuselages currently used today suffer from a number of disadvantages:
(a) They can't support an effective movement in any direction from a relative stopped position.
(b) They can't support an effective change in direction when at velocity.
(c) They can't support an effective relative stop maneuver in space from any directional vector.

### SUMMARY

In accordance with one embodiment an aerospace fuselage in the shape of a sphere capable of holding or mounting at least one or a plurality of propulsion devices.

### ADVANTAGES

Accordingly several advantages are as follows: to provide an aerospace fuselage that performs a more effective directional movement from a relative stopped position, a more effective change in direction while moving, and a more effective stopping maneuver when holding a plurality of propulsion devices.

### BRIEF DESCRIPTION OF THE DRAWING

FIG. 1. shows an aerospace fuselage in the shape of a sphere with a partially schematic cross-sectional view of the bulkhead where a portion of the invention has been removed.

### REFERENCE NUMERALS

1 spherical aerospace fuselage
2 bulkhead
3 locations for at least one propulsion devices to be mounted

### DETAILED DESCRIPTION

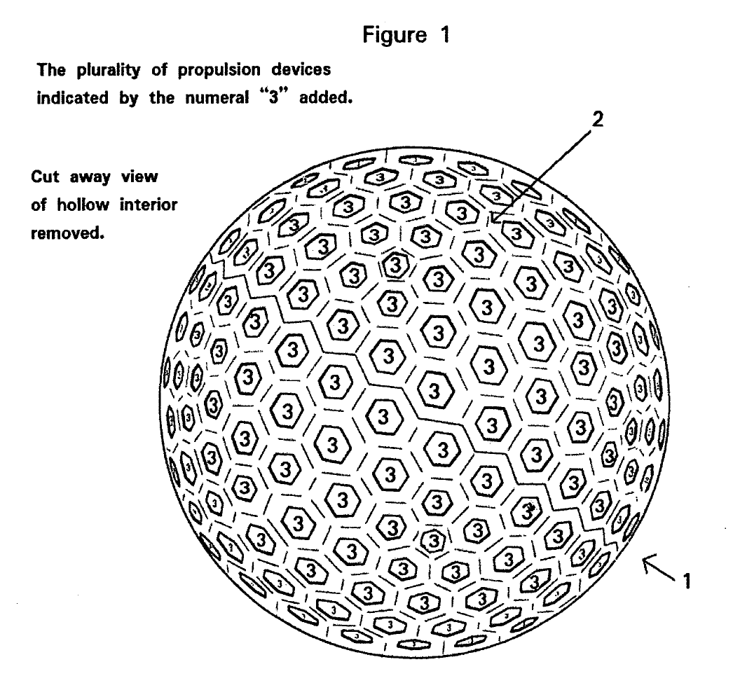

### FIG. 1

### First Embodiment

One embodiment of the invention is illustrated in FIG. 1. The spherical aerospace fuselage 1 comprises a bulkhead 2 a location for at least one propulsion device to be mounted 3.

### Operation—FIG. 1.

Build a spherical shaped fuselage in space. Mount a plurality of propulsion devices in or on the outside of its bulkhead like dimples on a golf ball. Ensure that the velocity effect on the sphere is directly towards or away from the center of the sphere depending on the propulsion device.

Selectively activate the propulsion devices as desired. It may be important to understand the true dangers of space time before proceeding.

### CONCLUSION, RAMIFICATIONS, AND SCOPE

Accordingly, the reader can instantly begin to see the ramifications and importance of such a morphological fuselage shape being built and used by the people of earth. By utilizing a plurality of propulsion devices, distributed around the fuselage, the human race can more effectively move through space. A plurality of rockets, for example, distributed around the spherical aerospace fuselage and pointing directly away from the center of the fuselage can now move a space vehicle into numerous directions. The human race has eliminated the need to rotate a vehicle to perform types of movements in space. A propulsion device is already at (or close to) the necessary location to perform types of movements in space. The inventions utility is clearly a more effective way to move through space.

The human race can now attempt a more effective directional movement from a relative stopped position into almost any directional vector without rotating the fuselage. By activating the necessary propulsion device the fuselage will begin to move in a desired direction. An aerospace vehicle fuselage in the shape of a sphere can be used to attempt a change in direction.

The human race can now attempt a more effective change in direction without rotating the fuselage. Once at velocity, a propulsion device can be activated to cause the fuselage to move in a direction different from its current direction of travel. Continued activation of the other propulsion devices can make further changes to directional vectors. This process can be used to ensure a more effective path direction. This process can be used to make sure you are eventually going in the right direction. An aerospace vehicle fuselage in the shape of a sphere can be used to attempt a stopping maneuver.

The human race can now attempt a more effective stopping maneuver without rotating the fuselage. When attempting to stop or slow a vehicle in space a propulsion device has to be activated in the exact opposite direction of travel. This is not easy. Any drifting being experienced by the fuselage (after the stopping maneuver has occurred) can also be removed utilizing the other propulsion devices. This process can be used to ensure a more effective stopping maneuver. This process can be used to make sure you come to a complete stop. The processes above are possible since there are many propulsion devices available distributed around the spherical aerospace fuselage.

Interestingly, an aerospace fuselage in the shape of a sphere can attempt an exact movement from a relative stopped position into a desired vector, an exact change in direction and an exact stopping maneuver since a propulsion device exactly where you need one to be might be available. And the chances of this occurring increases as the radius of the aerospace spherical fuselage increases. This fact indicates the importance of utilizing a larger spherical aerospace fuselage.

A larger spherical fuselage will produce more effective movements when holding a plurality of propulsion devices. A smaller spherical aerospace fuselage might not have a propulsion device that is exactly where you need one to be as explained above. More propulsion devices can be mounted on a larger spherical aerospace fuselage. Bigger is better.

In conclusion, when using propulsion to move through space an aerospace fuselage in the shape of a sphere is the best choice. More accurate movements, maneuvering, and stopping, are now possible. When considering the correct way to begin moving in space from a stopped position a spherical aerospace fuselage is the best choice. When considering changing your direction of travel a spherical aerospace fuselage is the best choice. When considering the concept of stopping an aerospace vehicle a spherical aerospace fuselage is the best choice.

Although the description above contains many specificities, these should not be construed as limiting the scope of the invention but as merely providing illustrations of some of the presently preferred embodiments of this invention disclosing the importance of the spherical shape for an aerospace fuselage.

Thus the scope of the embodiments should be determined by the appended claims and their legal equivalents, rather than by the examples given.

1. (canceled)

2. (canceled)

3. (canceled)

4. An aerospace vehicle comprising:
a fuselage in the shape of a sphere (1) used as a mounting apparatus for at least one propulsion devices (3), said mounting apparatus comprising a location for the means for supporting the chosen propulsion unit within the bulkhead (2) used to provide a movement vector directly away or towards the exact center of the sphere dependent of the type of propulsion device (3) used.
